(19) United States
(12) Patent Application Publication
(10) Pub. No.: US 2024/0388158 A1
(43) Pub. Date: Nov. 21, 2024

(54) MOTOR COIL SUBSTRATE AND MOTOR

(71) Applicant: IBIDEN CO., LTD., Ogaki (JP)

(72) Inventors: Takahisa HIRASAWA, Ogaki (JP); Takayuki FURUNO, Ogaki (JP)

(73) Assignee: IBIDEN CO., LTD., Ogaki (JP)

(21) Appl. No.: 18/786,689

(22) Filed: Jul. 29, 2024

Related U.S. Application Data
(63) Continuation of application No. PCT/JP2023/002176, filed on Jan. 25, 2023.

(30) Foreign Application Priority Data
Jan. 31, 2022 (JP) 2022-012947

(51) Int. Cl. H02K 3/28; H02K 3/26

(52) U.S. Cl. CPC H02K 3/28; H02K 3/26; H02K 2203/03

(57) ABSTRACT

A motor coil substrate includes a coil substrate including a flexible substrate and coils such that the coils include first wirings formed on a first surface of the flexible substrate and second wirings formed on a second surface of the flexible substrate on the opposite side. The coil substrate is wound N turns where N is an integer of 2 or more in a circumferential direction such that the first surface of the flexible substrate is positioned on an inner circumferential side of the coil substrate, the second surface of the flexible substrate is positioned on an outer circumferential side of the coil substrate, and a gap is formed between an M-th layer where M is an integer equal to or larger than 1 and less than N and an (M+1)-th layer from an inner side of N circumferential layers formed by winding the coil substrate N turns.

### CROSS-REFERENCE TO RELATED APPLICATIONS

The present application is a continuation of and claims the benefit of priority to International Application No. PCT/JP2023/002176, filed Jan. 25, 2023, which is based upon and claims the benefit of priority to Japanese Application No. 2022-012947, filed Jan. 31, 2022. The entire contents of these applications are incorporated herein by reference.

### BACKGROUND OF THE INVENTION

### Field of the Invention

The present invention relates to a motor coil substrate, and a motor formed using the motor coil substrate.

### Description of Background Art

Japanese Patent Application Laid-Open Publication No. 2020-182268 describes a coil substrate having a flexible substrate and spiral-shaped wirings formed on both sides of the flexible substrate. The entire contents of this publication are incorporated herein by reference.

### SUMMARY OF THE INVENTION

According to one aspect of the present invention, a motor coil substrate includes a coil substrate including a flexible substrate and coils such that the coils include first wirings formed on a first surface of the flexible substrate and second wirings formed on a second surface of the flexible substrate on the opposite side with respect to the first surface. The coil substrate is formed to be wound N turns where N is an integer of 2 or more in a circumferential direction such that the first surface of the flexible substrate is positioned on an inner circumferential side of the coil substrate, the second surface of the flexible substrate is positioned on an outer circumferential side of the coil substrate, and a gap is formed between an M-th layer where M is an integer equal to or larger than 1 and less than N and an (M+1)-th layer from an inner side of N circumferential layers formed by winding the coil substrate N turns.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a perspective view schematically illustrating a motor coil substrate according to an embodiment of the present invention;

FIG. 2 is a plan view schematically illustrating a coil substrate according to an embodiment of the present invention;

FIG. 3 is a cross-sectional view schematically illustrating a coil substrate according to an embodiment of the present invention;

FIG. 4 is an explanatory cross-sectional view schematically illustrating a portion of a motor coil substrate according to an embodiment of the present invention;

FIG. 5 is a cross-sectional view schematically illustrating a motor o according to an embodiment of the present invention;

FIG. 6 is a plan view schematically illustrating a coil substrate of a first modified example according to an embodiment of the present invention; and

FIG. 7 is a bottom view schematically illustrating the coil substrate of the first modified example.

### DETAILED DESCRIPTION OF THE EMBODIMENTS

Embodiments will now be described with reference to the accompanying drawings, wherein like reference numerals designate corresponding or identical elements throughout the various drawings.

### Embodiment

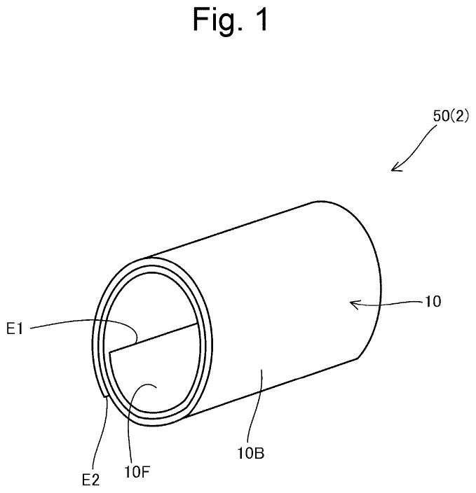

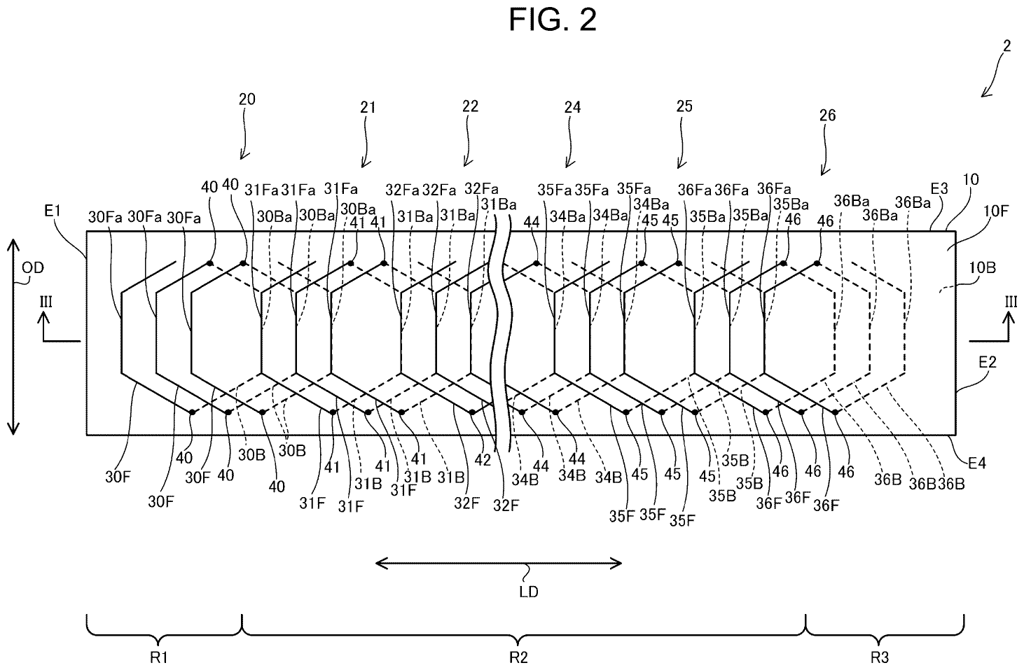

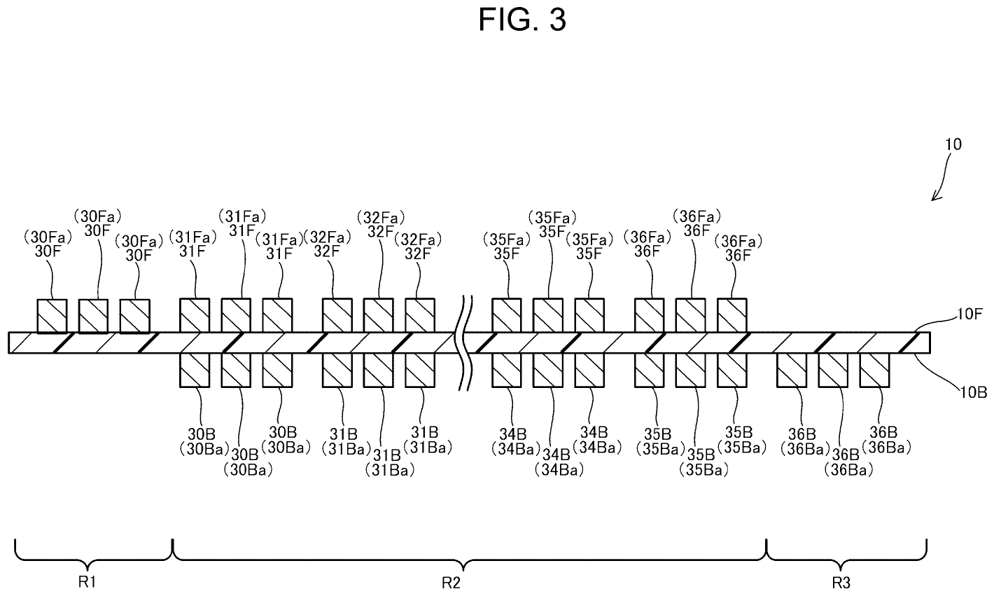

FIG. 1 is a perspective view schematically illustrating a motor coil substrate 50 of an embodiment. The motor coil substrate 50 is used as a component of a motor. The motor coil substrate 50 of the embodiment is formed by winding a coil substrate 2 (see FIGS. 2 and 3) N turns (N is an integer of 2 or more) into a cylindrical shape. In the example in FIG. 1, the motor coil substrate 50 is formed by winding the coil substrate 2 four turns. When the coil substrate 2 is wound into a cylindrical shape, with a first side (E1) (see FIG. 2) as a starting point, the coil substrate 2 is wound multiple turns in a circumferential direction around an axis extending in an orthogonal direction (an axis extending parallel to the first side (E1)). Further, the number of turns the coil substrate is wound is not particularly limited. When the coil substrate 2 is wound into a cylindrical shape, the first surface (10F) of the flexible substrate 10 of the core substrate 2 is positioned on the inner circumferential side, and the second surface (10B) is positioned on the outer circumferential side. A gap is formed between an M-th layer (where M is an integer equal to or larger than 1 and less than N) and an (M+1)-th layer from an inner side of N circumferential layers formed by winding the coil substrate N turns. There are no particular limitations on formation positions, sizes, and number of gaps.

FIG. 2 is a plan view illustrating the coil substrate 2. FIG. 3 is a cross-sectional view between III-III of FIG. 2. As illustrated in FIG. 2, the coil substrate 2 has the flexible substrate 10 and multiple coils (20, 21, 22, 24, 25, 26). Although FIG. 2 illustrates only the coils (20, 21, 22, 24, 25, 26), the coil substrate 2 also has coils other than the coils (20, 21, 22, 24, 25, 26).

The flexible substrate 10 is a resin substrate having a first surface (10F) and a second surface (10B) on the opposite side with respect to the first surface (10F). The flexible substrate 10 is formed using an insulating resin such as polyimide or polyamide. The flexible substrate 10 is flexible. The flexible substrate 10 is formed in a rectangular shape having four sides, first side (E1)—fourth side (E4). The first side (E1) is a short side on one end side of the flexible substrate 10 in a longitudinal direction (arrow (LD) direction in FIG. 1). The second side (E2) is a short side on the other end side in the longitudinal direction. The first side (E1) and the second side (E2) are short sides extending along an orthogonal direction (arrow (OD) direction in FIG. 1) that is orthogonal to the longitudinal direction. The third side (E3) and the fourth side (E4) are long sides extending in the longitudinal direction. When the coil substrate 2 is wound into a cylindrical shape to form the motor coil substrate 50 (see FIG. 1), the first surface (10F) is positioned on an inner circumferential side and the second surface (10B) is positioned on an outer circumferential side.

In FIGS. 2 and 3, illustration of a middle portion in the longitudinal direction of the flexible substrate 10 is omitted. The flexible substrate 10 has a first region (R1) adjacent to the first side (E1), a second region (R2) next to the first region (R1), and a third region (R3) next to the second region (R2) and adjacent to the second side (E2). The second region (R2) is a region between the first region (R1) and the third region (R3).

The coils (20, 21, 22, 24, 25, 26) are formed along the longitudinal direction of the flexible substrate 10. The coils (20, 21, 22) and the coils (24, 25, 26) may each respectively form a U phase, a V phase, and a W phase of a three-phase motor. The coils (20, 21, 22, 24, 25, 26) are formed in this order from the first side (E1) to the second side (E2). Other coils (not illustrated) are provided between the coils (20, 21, 22) and the coils (24, 25, 26). The coils are formed by first wirings (see reference numeral symbols “30F,” “31F,” and the like in FIG. 2) provided on the first surface (10F) and second wirings (see reference numeral symbols “30B,” “31B,” and the like) provided on the second surface (10B).

The coil 20 is formed by forming first wirings (30F) on the first surface (10F) side, each forming a half turn of one turn, and second wirings (30B) on the second surface (10B) side, each forming a remaining half turn, with adjacent turns being formed in a staggered manner. In FIG. 2, the coil 20 has wirings for three turns. The first wirings (30F) and second wirings (30B) forming the turns are electrically connected via via conductors 40 penetrating the flexible substrate 10. The first wirings (30F) each have a first orthogonal part (30Fa) extending along the orthogonal direction (see the arrow (OD)). The second wirings (30B) also each have a second orthogonal part (30Ba) extending along the orthogonal direction. The coil 20 is formed extending over the first region (R1) and the second region (R2) of the flexible substrate 10. The first wirings (30F) are formed in the first region (R1). The second wirings (30B) are not formed in the first region (R1). The second wirings (36B) are formed in the second region (R2).

Similarly, the coil 21 is formed by forming first wirings (31F) on the first surface (10F) side, each forming a half turn of one turn, and second wirings (31B) on the second surface (10B) side, each forming a remaining half turn, with adjacent turns being formed in a staggered manner. The coil 21 has wirings for three turns. The first wirings (31F) and second wirings (31B) forming the turns are electrically connected via via conductors 41. The first wirings (31F) each have a first orthogonal part (31Fa) extending along the orthogonal direction (see the arrow (OD)). The second wirings (31B) also each have a second orthogonal part (31Ba) extending along the orthogonal direction. The coil 21 is entirely formed in the second region (R2) of the flexible substrate 10. That is, the first wirings (31F) and second wirings (31B) are formed in the second region (R2).

Similarly, the coil 22 also includes first wirings (32F) and second wirings (not illustrated) for three turns. The first wirings (32F) and the second wirings are connected via via conductors 42. The first wirings (32F) each have a first orthogonal part (32Fa), and the second wirings each have a second orthogonal part. The coil 22 also is entirely formed in the second region (R2) of the flexible substrate 10.

As illustrated in FIGS. 2 and 3, the second orthogonal parts (30Ba) of the second wirings (30B) forming the coil 20 respectively overlap the first orthogonal parts (31Fa) of the first wirings (31F) forming the adjacent coil 21 with the flexible substrate 10 in between. The second orthogonal parts (31Ba) of the second wirings (31B) forming the coil 21 respectively overlap the first orthogonal parts (32Fa) of the first wirings (32F) forming the adjacent coil 22 with the flexible substrate 10 in between.

The coil 24 also includes first wirings (not illustrated) and second wirings (34B) for three turns. The first wirings and the second wirings (34B) are connected via via conductors 44. The first wirings each have a first orthogonal part, and the second wirings (34B) each have a second orthogonal part (34Ba). The coil 24 also is entirely formed in the second region (R2) of the flexible substrate 10.

The coil 25 also includes first wirings (35F) and second wirings (35B) for three turns. The first wirings (35F) and the second wirings (35B) are connected via via conductors 45. The first wirings (35F) each have a first orthogonal part (35Fa), and the second wirings (35B) each have a second orthogonal part (35Ba). The coil 25 also is entirely formed in the second region (R2) of the flexible substrate 10.

The coil 26 also includes first wirings (36F) and second wirings (36B) for three turns. The first wirings (36F) and the second wirings (36B) are connected via via conductors 46. The first wirings (36F) each have a first orthogonal part (36Fa), and the second wirings (36B) each have a second orthogonal part (36Ba). The coil 26 is formed extending over the second region (R2) and the third region (R3) of the flexible substrate 10. The first wirings (36F) are formed in the second region (R2). The second wirings (36B) are formed in the third region (R3). The first wirings (36F) are not formed in the third region (R3).

The second orthogonal parts (34Ba) of the second wirings (34B) forming the coil 24 respectively overlap the first orthogonal parts (35Fa) of the first wirings (35F) forming the adjacent coil 25 with the flexible substrate 10 in between. The second orthogonal parts (35Ba) of the second wirings (35B) forming the coil 25 respectively overlap the first orthogonal parts (36Fa) of the first wirings (36F) forming the adjacent coil 26 with the flexible substrate 10 in between.

The formation in FIGS. 2 and 3 is merely an example. In other modified examples, it is also possible that the second orthogonal parts (30Ba) of the second wirings (30B) forming the coil 20 do not respectively overlap the first orthogonal parts (31Fa) of the first wirings (31F) forming the immediately adjacent coil 21 as long as they respectively overlap the first orthogonal parts of the first wirings forming another coil (for example, the first orthogonal parts of the first wirings of a third adjacent coil). The same applies to the coils (21, 22, 24, 25, 26). When either structure is adopted, it is sufficient that the first wirings (30F, 31F) and the like are formed in the first region (R1) and the second wirings (30B, 31B) and the like are not formed in the first region (R1). It is sufficient that the second wirings (36B, 35B) and the like are formed in the third region (R3) and the first wirings (36F, 35F) and the like are not formed in the third region (R3).

In a modified example, in the first region (R1), the first wirings (30F, 31F) and the like may be formed and the second wirings (30B, 31B) and the like may also be formed. In another modified example, in the first region (R1), while the first wirings (30F, 31F) and the like may be formed, the second wirings (30B, 31B) and the like may not be formed. In a modified example, in the third region (R3), the second wirings (36B, 35B and the like may be formed and the first wirings (36F, 35F) and the like may also be formed. In yet another modified example, in the third region (R3), while the second wirings (36B, 35B) and the like may be formed, the first wirings (36F, 35F) and the like may not be formed.

Although not illustrated, the first surface (10F), and the first wirings (30F) and the like are covered with a resin insulation layer. Similarly, the second surface (10B) and the second wirings (30B) and the like are covered with a resin insulation layer.

In the embodiment, the motor coil substrate 50 in FIG. 1 is formed by winding the coil substrate 2 (FIGS. 2 and 3) four turns in the circumferential direction with the first side (E1) as a starting point. In the motor coil substrate 50, the first surface (10F) of the flexible substrate 10 is positioned on the inner circumferential side, and the second surface (10B) is positioned on the outer circumferential side.

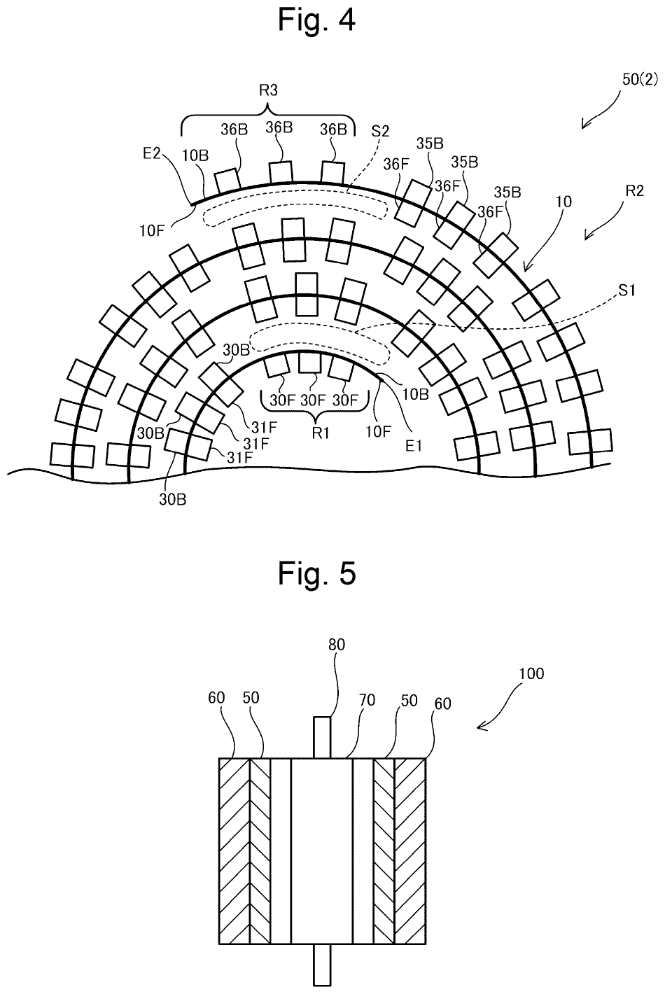

FIG. 4 is an explanatory cross-sectional view schematically illustrating a part of the motor coil substrate 50 of FIG. 1. As illustrated, the motor coil substrate 50 has a first layer, a second layer, a third layer, and a fourth layer in order from the innermost circumferential layer. The first region (R1) and a portion of the second region (R2) form the innermost circumferential first layer. The second region (R2) forms the second layer and the third layer. A portion of the second region (R2) and the third region (R3) form the outermost circumferential fourth layer.

As illustrated in FIG. 4, a gap (S1) is formed between the first layer and the second layer. A gap (S2) is formed between the third layer and the fourth layer.

In the first region (R1) adjacent to the starting end when the coil substrate 2 is wound, the second wirings (30B) on the second surface (10B) are not formed, and only the first wirings (30F) provided on the first surface (10F) are formed. Therefore, in the first region (R1) portion of the innermost circumferential first layer, no wirings are formed on the outer circumferential side (second surface (10B) side), and wirings (first wirings (30F)) are formed only on the inner circumferential side (first surface (10F) side). A region where no wirings are formed is formed on the outer circumferential side of the first layer. Therefore, when the flexible substrate 10 of the second layer (that is, the second innermost circumferential layer) is wound on an outer side of the first layer, the gap (S1) between the first layer and the second layer is formed. The gaps (S1, S2) illustrated in FIG. 4 are merely examples. In the modified example, there are no particular limitations on formation positions, sizes, and number of gaps.

Further, in the third region (R3) adjacent to the terminating end when the coil substrate 2 is wound, only the second wirings (36B) provided on the second surface (10B) are formed, and the first wirings (36F) provided on the first surface (10F) are not formed. Therefore, in the third region (R3) portion of the outermost circumferential fourth layer, no wirings are formed on the inner circumferential side (first surface (10F) side), and wirings (second wirings (36B)) are formed only on the outer circumferential side (second surface (10B) side). A region where no wirings are formed is formed on the inner circumferential side of the fourth layer. Therefore, the gap (S2) is formed between the third layer and the fourth layer.

The motor coil substrate 50 of the embodiment has the gaps (S1, S2), and thus can be formed into a cylindrical shape with a substantially perfect circular cross section.

FIG. 5 is a cross-sectional view schematically illustrating a motor 100 formed using the motor coil substrate 50 of the embodiment (FIGS. 1 and 4). The motor 100 is formed by positioning the motor coil substrate 50 on an inner side of a yoke 60 and positioning a rotation shaft 80 and a magnet 70 fixed to the rotation shaft 80 on an inner side of the motor coil substrate 50.

In the above, the structures of the motor coil substrate 50 (FIGS. 1 and 4), the coil substrate 2 (FIGS. 2 and 3), and the motor 100 (FIG. 5) of the embodiment have been described. By using the coil substrate 2 of the embodiment, the motor coil substrate 50 can be formed into a cylindrical shape with a substantially perfect circular cross section. Therefore, when the motor 100 is formed, interference between the magnet 70, which is positioned on the inner side of the motor coil substrate 50, and the motor coil substrate 50 is prevented. Further, since a gap between the motor coil substrate 50 and the yoke 60 becomes constant, high heat dissipation performance is achieved. Therefore, when the motor 100 is formed using the coil substrate 2 of the embodiment, a motor 100 with stable performance can be obtained.

### First Modified Example

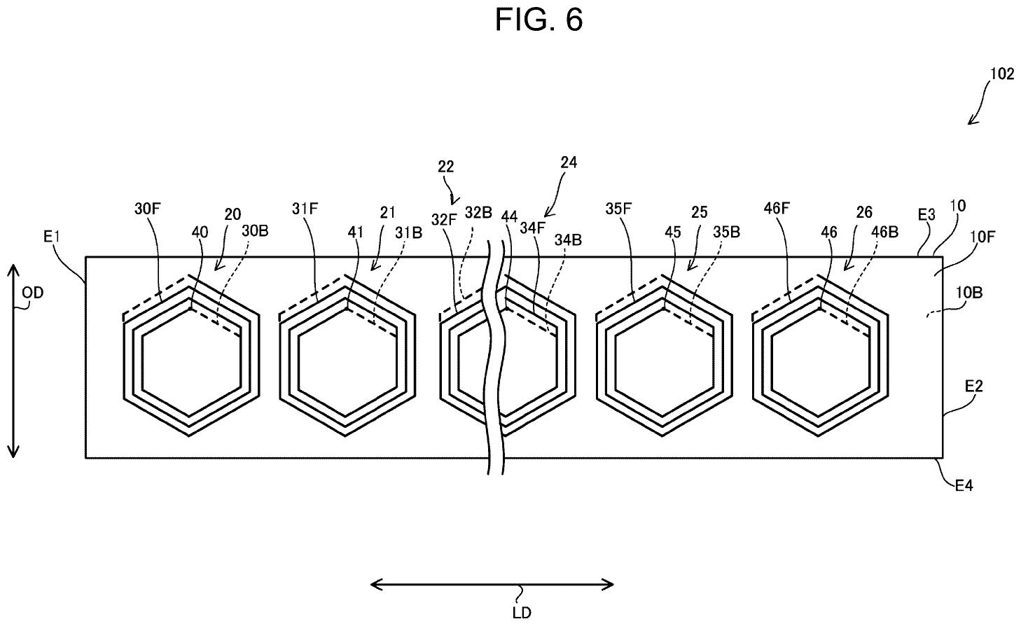

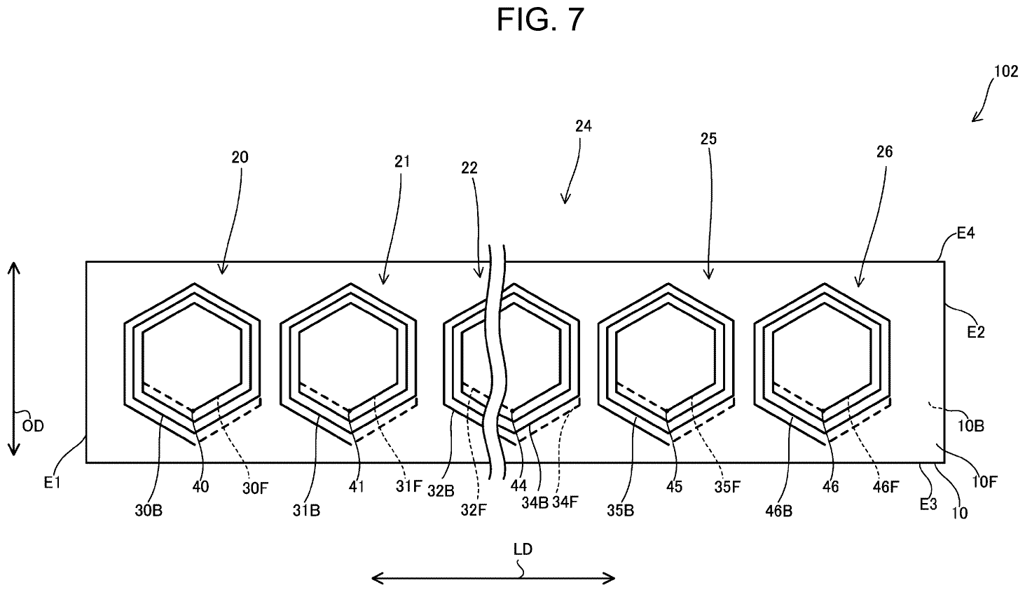

FIGS. 6 and 7 illustrate a first modified example of the embodiment. In the first modified example, the formation of the wirings forming the coils (20, 21, 22, 24, 25, 26) is different from that in the embodiment. FIG. 6 is a plan view illustrating a coil substrate 102 of the first modified example. FIG. 7 is a bottom view illustrating the coil substrate 102 of the first modified example. As illustrated in FIGS. 6 and 7, in the first modified example, a first wiring (30F) and a second wiring (30B) that form the coil 20 are each formed in a spiral shape (hexagonal spiral shape). The first wiring (30F) and the second wiring (30B) are connected via a via conductor.

Also in this case, a gap is formed between an M-th layer (where M is an integer equal to or larger than 1 and less than N) and an (M+1)-th layer from an inner side of N circumferential layers formed by winding the coil substrate 102 N turns. In the first modified example, there are no particular limitations on formation positions, sizes, and number of gaps. For example, the motor coil substrate 50 may be formed by winding the coil substrate 102 six turns. In this case, a gap may be formed between the third layer and the fourth layer from an inner side. The coils are not limited in shape as long as the coils each have a spiral shape.

### Second Modified Example

Although not illustrated, in a coil substrate 2 of a second modified example, a first wiring (30F) and a second wiring (30B) that form the coil 20 are each formed in a spiral shape (hexagonal spiral shape). The first wiring (30F) and the second wiring (30B) are connected via a via conductor. The first wiring (30F) and the second wiring (30B) are formed in an offset manner. The coils (21, 22, 24, 25, 26) and the like also each have a similar structure.

Also in the second modified example, the first wirings (wirings on the first surface (10F) side) are formed in the first region (R1), and no second wirings (wirings on the second surface (10B) side) are formed in the first region (R1). The second wirings are formed in the third region (R3), and no first wirings are formed in the third region (R3).

Therefore, when the coil substrate 2 of the second modified example is wound to form the motor coil substrate 50, similar to that in the embodiment, in the first region (R1) portion of the first layer, no wirings are formed on the outer circumferential side (second surface (10B) side), and wirings (first wirings) are formed only on the inner circumferential side (first surface (10F) side). A region where no wirings are formed is formed on the outer circumferential side of the first layer. Therefore, when the flexible substrate 10 of the second layer is wound on an outer side of the first layer, a gap between the first layer and the second layer is formed. Further, in the third region (R3) portion of the outermost circumferential fourth layer, no wirings are formed on the inner circumferential side (first surface (10F) side), and wirings (second wirings) are formed only on the outer circumferential side (second surface (10B) side). A region where no wirings are formed is formed on the inner circumferential side of the fourth layer. Therefore, a gap is also formed between the third layer and the fourth layer. The motor coil substrate 50 can be formed into a cylindrical shape with a substantially perfect circular cross section.

Also in this case, a gap is formed between an M-th layer (where M is an integer equal to or larger than 1 and less than N) and an (M+1)-th layer from an inner side of N circumferential layers formed by winding the coil substrate 2 N turns. In the second modified example, there are no particular limitations on formation positions, sizes, and number of gaps. For example, the motor coil substrate 50 may be formed by winding the coil substrate 2 ten turns. In this case, a gap may be formed between the third layer and the fourth layer, or between the seventh layer and the eighth layer, from an inner side. The coils are not limited in shape as long as the coils each have a spiral shape.

### Third Modified Example

In the third modified example, the formation of the coils is the same as that of the embodiment, and the motor coil substrate 50 is formed by winding the coil substrate 2 N turns (N is an integer of 2 or more). Also in this case, a gap is formed between an M-th layer (where M is an integer equal to or larger than 1 and less than N) and an (M+1)-th layer from an inner side of N circumferential layers formed by winding the coil substrate 2 N turns. In the third modified example, there are no particular limitations on formation positions, sizes, and number of gaps. For example, the motor coil substrate 50 may be formed by winding the coil substrate 2 ten turns. In this case, a gap may be formed between the first layer and the second layer, and between the ninth layer and the tenth layer, from an inner side.

Japanese Patent Application Laid-Open Publication No. 2020-182268 describes a coil substrate having a flexible substrate and spiral-shaped wirings formed on both sides of the flexible substrate. A motor coil substrate is formed by winding the coil substrate in a circumferential direction.

In the technology of Japanese Patent Application Laid-Open Publication No. 2020-182268, it is thought that the motor coil substrate formed by winding the coil substrate is formed into a polygonal cylindrical shape with a polygonal cross section instead of a cylindrical shape with a circular cross section. Therefore, it is thought that an outer circumferential shape of the coil substrate does not have a uniform thickness. As a result, it is thought that it interferes with a magnet positioned on an inner side when a motor is formed. Further, in the motor, since a gap between the motor coil substrate and a yoke is increased, it is thought that heat dissipation performance deteriorates. It is thought that stable motor performance cannot be achieved.

A motor coil substrate according to an embodiment of the present invention is formed by winding a coil substrate N turns (where N is an integer of 2 or more) in a circumferential direction, the coil substrate having a flexible substrate and multiple coils, the flexible substrate having a first surface and a second surface on the opposite side with respect to the first surface, and the coils being formed by first wirings provided on the first surface and second wirings provided on the second surface. The first surface is positioned on an inner circumferential side, and the second surface is positioned on an outer circumferential side, and a gap is formed between an M-th layer (where M is an integer equal to or larger than 1 and less than N) and an (M+1)-th layer from an inner side of N circumferential layers formed by winding the coil substrate N turns.

In a motor coil substrate according to an embodiment of the present invention, a gap is formed between the M-th layer and the (M+1)-th layer. Therefore, the motor coil substrate can be formed into a cylindrical shape with a substantially perfect circular cross section. As a result, occurrence of a short circuit between the wirings is suppressed. Further, when a motor is formed by positioning the motor coil substrate, a magnet, and a yoke in a casing, interference between the magnet, which is positioned on an inner side of the motor coil substrate, and the motor coil substrate is prevented. Further, since a gap between the motor coil substrate and the yoke becomes constant, high heat dissipation performance is achieved. Therefore, when a motor is formed using a coil substrate according to an embodiment of the present invention, a motor with stable performance can be obtained.

In a motor coil substrate according to an embodiment of the present invention, the coil substrate may be wound N turns in the circumferential direction around an axis extending in an orthogonal direction orthogonal to a longitudinal direction of the flexible substrate with a first end in the longitudinal direction as a starting point. The flexible substrate may have a first region adjacent to the first end, and a second region adjacent to the first region. The first wirings may be formed in the first region adjacent to the first end, and the second wirings may not be formed in the first region.

In a motor coil substrate according to an embodiment of the present invention, the flexible substrate may further have a third region adjacent to the second region and adjacent to a second end on the opposite side with respect to the first end. The second wirings may be formed in the third region. The first wirings may not be formed in the third region.

In a motor coil substrate according to an embodiment of the present invention, the multiple coils may each include the first wirings of half turns formed on the first surface, the second wirings of half turns formed on the second surface, and via conductors connecting the first wirings and the second wirings.

A motor according to an embodiment of the present invention is formed by positioning a motor coil substrate according to an embodiment of the present invention on an inner side of a cylindrical yoke and positioning a rotation shaft and a magnet on an inner side of the motor coil substrate.

In a motor according to an embodiment of the present invention, interference between the magnet and the motor coil substrate is prevented. Further, since a gap between the motor coil substrate and the yoke also becomes constant, high heat dissipation performance is achieved. A motor with stable performance can be obtained.

Obviously, numerous modifications and variations of the present invention are possible in light of the above teachings. It is therefore to be understood that within the scope of the appended claims, the invention may be practiced otherwise than as specifically described herein.

1. A motor coil substrate, comprising:
a coil substrate comprising a flexible substrate and a plurality of coils such that the plurality of coils includes a plurality of first wirings formed on a first surface of the flexible substrate and a plurality of second wirings formed on a second surface of the flexible substrate on an opposite side with respect to the first surface,
wherein the coil substrate is configured to be wound N turns where N is an integer of 2 or more in a circumferential direction such that the first surface of the flexible substrate is positioned on an inner circumferential side of the coil substrate, the second surface of the flexible substrate is positioned on an outer circumferential side of the coil substrate, and a gap is formed between an M-th layer where M is an integer equal to or larger than 1 and less than N and an (M+1)-th layer from an inner side of N circumferential layers formed by winding the coil substrate N turns.

2. The motor coil substrate according to claim 1, wherein the coil substrate has a first end in a longitudinal direction of the flexible substrate and is configured to be wound N turns from the first end in the circumferential direction around an axis extending in an orthogonal direction orthogonal to the longitudinal direction such that the flexible substrate has a first region adjacent to the first end and that the first region includes the first wirings and does not include the second wirings.

3. The motor coil substrate according to claim 2, wherein the flexible substrate has a second region adjacent to the first region and a third region adjacent to the second region and a second end of the flexible substrate on an opposite side with respect to the first end such that third region includes the second wirings and does not include the first wirings.

4. The motor coil substrate according to claim 1, wherein the coil substrate is formed such that each of the coils includes a plurality of half turns of the first wirings formed on the first surface, a plurality of half turns of the second wirings formed on the second surface, and a plurality of via conductors connecting the first wirings and the second wirings.

5. A motor, comprising:
a cylindrical yoke;
the motor coil substrate of claim 1 formed on an inner side of the cylindrical yoke;
a magnet formed on the inner side of the cylindrical yoke such that the magnet is formed on an inner side of the motor coil substrate; and
a rotation shaft formed on the inner side of the cylindrical yoke such that the rotation shaft is formed on an inner side of the magnet.

6. The motor coil substrate according to claim 2, wherein the coil substrate is formed such that each of the coils includes a plurality of half turns of the first wirings formed on the first surface, a plurality of half turns of the second wirings formed on the second surface, and a plurality of via conductors connecting the first wirings and the second wirings.

7. A motor, comprising:
a cylindrical yoke;
the motor coil substrate of claim 2 formed on an inner side of the cylindrical yoke;
a magnet formed on the inner side of the cylindrical yoke such that the magnet is formed on an inner side of the motor coil substrate; and
a rotation shaft formed on the inner side of the cylindrical yoke such that the rotation shaft is formed on an inner side of the magnet.

8. The motor coil substrate according to claim 3, wherein the coil substrate is formed such that each of the coils includes a plurality of half turns of the first wirings formed on the first surface, a plurality of half turns of the second wirings formed on the second surface, and a plurality of via conductors connecting the first wirings and the second wirings.

9. A motor, comprising:
a cylindrical yoke;
the motor coil substrate of claim 3 formed on an inner side of the cylindrical yoke;
a magnet formed on the inner side of the cylindrical yoke such that the magnet is formed on an inner side of the motor coil substrate; and
a rotation shaft formed on the inner side of the cylindrical yoke such that the rotation shaft is formed on an inner side of the magnet.

10. A motor, comprising:
a cylindrical yoke;
the motor coil substrate of claim 4 formed on an inner side of the cylindrical yoke;
a magnet formed on the inner side of the cylindrical yoke such that the magnet is formed on an inner side of the motor coil substrate; and
a rotation shaft formed on the inner side of the cylindrical yoke such that the rotation shaft is formed on an inner side of the magnet.

11. The motor coil substrate according to claim 2, wherein the coil substrate is formed such that the coils are lined up along the longitudinal direction of the flexible substrate.

12. The motor coil substrate according to claim 11, wherein the flexible substrate has a second region adjacent to the first region and a third region adjacent to the second region and a second end of the flexible substrate on an opposite side with respect to the first end such that third region includes the second wirings and does not include the first wirings.

13. The motor coil substrate according to claim 11, wherein the coil substrate is formed such that each of the coils includes a plurality of half turns of the first wirings formed on the first surface, a plurality of half turns of the second wirings formed on the second surface, and a plurality of via conductors connecting the first wirings and the second wirings.

14. A motor, comprising:
a cylindrical yoke;
the motor coil substrate of claim 11 formed on an inner side of the cylindrical yoke;
a magnet formed on the inner side of the cylindrical yoke such that the magnet is formed on an inner side of the motor coil substrate; and
a rotation shaft formed on the inner side of the cylindrical yoke such that the rotation shaft is formed on an inner side of the magnet.

15. The motor coil substrate according to claim 12, wherein the coil substrate is formed such that each of the coils includes a plurality of half turns of the first wirings formed on the first surface, a plurality of half turns of the second wirings formed on the second surface, and a plurality of via conductors connecting the first wirings and the second wirings.

16. The coil substrate according to claim 1, wherein the plurality of coils includes a U phase coil, a V phase coil, and a W phase coil and is formed such that the coils are lined up along the longitudinal direction of the flexible substrate.

17. The motor coil substrate according to claim 16, wherein the flexible substrate has a second region adjacent to the first region and a third region adjacent to the second region and a second end of the flexible substrate on an opposite side with respect to the first end such that third region includes the second wirings and does not include the first wirings.

18. The motor coil substrate according to claim 16, wherein the coil substrate is formed such that each of the coils includes a plurality of half turns of the first wirings formed on the first surface, a plurality of half turns of the second wirings formed on the second surface, and a plurality of via conductors connecting the first wirings and the second wirings.

19. A motor, comprising:
a cylindrical yoke;
the motor coil substrate of claim 16 formed on an inner side of the cylindrical yoke;
a magnet formed on the inner side of the cylindrical yoke such that the magnet is formed on an inner side of the motor coil substrate; and
a rotation shaft formed on the inner side of the cylindrical yoke such that the rotation shaft is formed on an inner side of the magnet.

20. The motor coil substrate according to claim 17, wherein the coil substrate is formed such that each of the coils includes a plurality of half turns of the first wirings formed on the first surface, a plurality of half turns of the second wirings formed on the second surface, and a plurality of via conductors connecting the first wirings and the second wirings.
